(19) United States
(12) Patent Application Publication
(10) Pub. No.: US 2011/0042056 A1
(43) Pub. Date: Feb. 24, 2011

(54) COOLING SYSTEM FOR MODULAR LIGHT EMITTING DIODE LIGHTING FITTING

(76) Inventor: Byung Am BAE, Busan (KR)

Correspondence Address: BIRCH STEWART KOLASCH & BIRCH, PO BOX 747, FALLS CHURCH, VA, 22040-0747, US

(21) Appl. No.: 12/707,366

(22) Filed: Feb. 17, 2010

(30) Foreign Application Priority Data
Aug. 19, 2009 (KR) 20-2009-0010917

(51) Int. Cl. F28F 27/00; F25B 21/02; F28F 7/00; F21V 29/00; F28D 15/00

(52) U.S. Cl. 165/247; 62/3.2; 165/185; 165/104.34

(57) ABSTRACT

A cooling system for a modular light emitting diode (LED) lighting fitting includes a heat sink, at least one cooling fan located at an upper portion of the heat sink and inducing heat radiating from the heat sink to an outside to cool the heat sink, at least one thermoelectric element provided at a lower portion of the heat sink and having a heat absorbing part in contact with the LED lighting fitting at a lower portion thereof and a heat radiating part in contact with the heat sink at an upper portion thereof, and at least one temperature sensor mounted at the lower portion of the heat sink. The cooling fan is controllably driven to cool the LED lighting fitting according to whether or not a temperature measured by the temperature sensor reaches a preset temperature.

### BACKGROUND OF THE INVENTION

1. Field of the Invention

The present invention relates to a cooling system for a modular light emitting diode (LED) lighting fitting, which is installed at an upper portion of the LED lighting fitting and is capable of more efficiently, rapidly cooling heat from the LED lighting fitting.

2. Description of the Related Art

The invention of the lighting device called an incandescent lamp was of benefit to mankind in that it released mankind from darkness and thus enabled mankind to work at night. As such, human civilization has more rapidly developed.

From that time on, mankind has made efforts to develop a lighting device that emits brighter light yet consumes low power. As a result, a lot of lighting devices such as fluorescent lamps, compact fluorescent lamps, halogen lamps, etc. has been invented up to the present and are used in our daily life.

With the recent development of light emitting diode (LED) elements that emit light when current flows, interest has been shown in using characteristics of the LED element for the lighting device. The LED elements emit high-luminance light with low power and they have a long lifetime, and thus are regarded as next-generation lighting devices. For this reason, the LED elements continue to be actively studied, and some of them come have onto the market as products.

These lighting devices must have a predetermined level of luminance. Thus, in order to produce a single LED lighting device using the LED elements, a plurality of LED bulbs configured of the LED elements must be densely arranged on the single LED lighting device.

Meanwhile, in the case where the LED bulbs are used in isolation as display lamps for household electric appliances such as televisions, telephones, etc., there is no problem with heat generated from each LED bulb. However, in the case of the LED lighting device where numerous LED bulbs are densely arranged, the heat generated from each LED bulb causes the LED lighting device a fatal problem.

Although LED lighting devices have a primarily much longer lifetime than existing lamps, the LED lighting device suffers from frequent failure and a short lifetime due to a lot of heat being generated from the numerous LED bulbs. As such, the LED lighting device has no alternative but to use low-powered LED bulbs and a small number of LED bulbs. Furthermore, since the LED lighting device has much lower illuminance and costs more compared to existing lamps such as incandescent lamps, mercury lamps, or fluorescent lamps, the LED lighting device has difficulty in being widely used as the lighting device.

For this reason, a method of mounting the LED elements to a metal printed circuit board (PCB) having good thermal conductivity, attaching a heat sink to the metal PCB, and dissipating the heat to the outside has been tried out. However, this method still has difficulty realizing an LED lighting device having high output power and luminance.

Accordingly, in order to realize the LED lighting device having higher luminance and output power, there is an acute need for a method capable of more efficiently dissipating the generated heat to rapidly cool the LED lighting device.

### SUMMARY OF THE INVENTION

Accordingly, the present invention has been made keeping in mind the above problems occurring in the related art, and embodiments of the present invention provide a cooling system for a modular light emitting diode (LED) lighting fitting, which more efficiently cools the LED lighting fitting, is capable of realizing the LED lighting fitting having high output power, high luminance, and high durability.

According to embodiments of the present invention, there is provided a cooling system for a modular LED lighting fitting, in which the cooling system is installed at an upper portion of the LED lighting fitting having a plurality of LED bulbs. The cooling system includes a heat sink, at least one cooling fan located at an upper portion of the heat sink and inducing heat radiating from the heat sink to an outside to cool the heat sink, at least one thermoelectric element provided at a lower portion of the heat sink and having a heat absorbing part in contact with the LED lighting fitting at a lower portion thereof and a heat radiating part contacted with the heat sink at an upper portion thereof, and at least one temperature sensor mounted at the lower portion of the heat sink. The cooling fan is controllably driven to cool the LED lighting fitting according to whether or not the temperature measured by the temperature sensor has reached a preset temperature.

Here, the cooling system may further include a fixing plate at the lower portion of the thermoelectric element.

According to embodiments of the present invention, the cooling system for the modular LED lighting fitting can more efficiently, rapidly cool the LED lighting fitting to realize the LED lighting fitting having high output power, luminance and durability.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a perspective view illustrating a cooling system for a light emitting diode (LED) lighting fitting according to an embodiment of the present invention;

FIG. 2 is a perspective view illustrating an arrangement of thermoelectric elements in accordance with an embodiment of the present invention; and

FIG. 3 is an exploded view illustrating a cooling system for an LED lighting fitting according to an embodiment of the present invention.

### DETAILED DESCRIPTION OF THE INVENTION

Reference will now be made in greater detail to exemplary embodiments of the invention with reference to the accompanying drawings. Wherever possible, the same reference numerals will be used throughout the drawings and the description to refer to the same or like parts. The detailed descriptions of known functions and constructions which would unnecessarily obscure the subject matter of the present invention will be avoided hereinafter. Technical terms, as mentioned hereinafter, are terms defined in light of their function in the present invention, which may vary according to the intention or practice of a user or operator, so that the terms should be defined based on the contents of this specification.

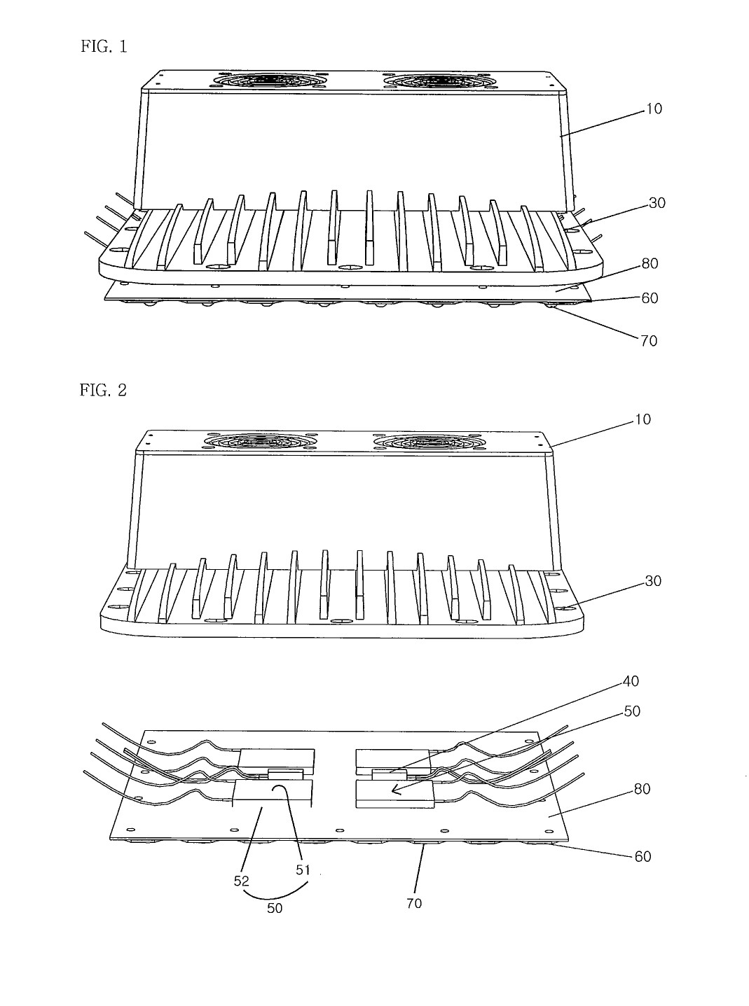

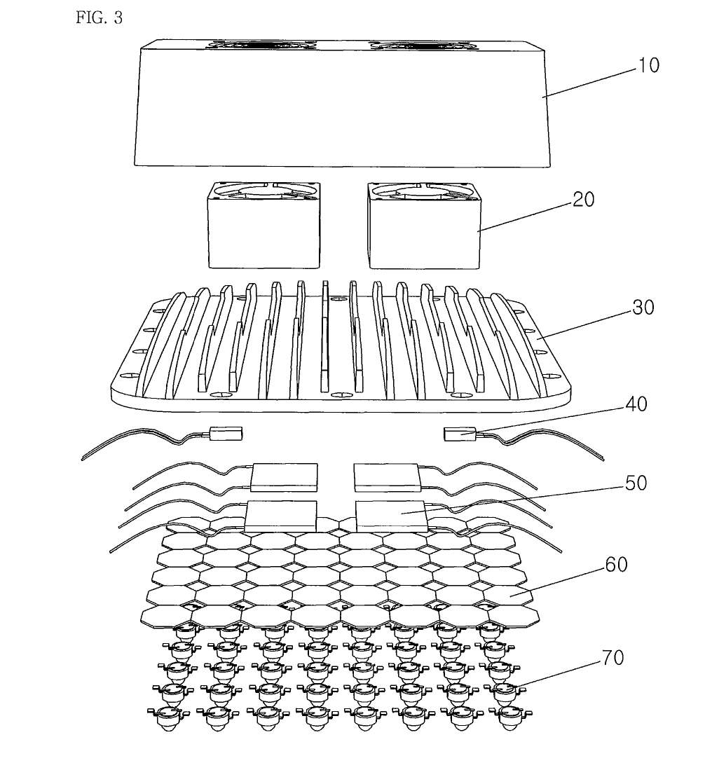

FIG. 1 is a perspective view illustrating a cooling system for a light emitting diode (LED) lighting fitting according to an embodiment of the present invention. FIG. 2 is a perspective view illustrating arrangement of thermoelectric elements in accordance with an embodiment of the present invention. FIG. 3 is an exploded view illustrating a cooling system for an LED lighting fitting according to an embodiment of the present invention.

In the cooling system for an LED lighting fitting according to an embodiment of the present invention, the LED lighting fitting may be, but is not limited to, a modular LED lighting fitting, which includes a plurality of metal printed circuit boards (PCBs) 60 and a plurality of LED bulbs 70 mounted under the metal PCBs 60.

Each metal PCB 60 is a board that is formed of metal having high thermal conductivity, for instance aluminum material, so as to easily dissipate heat generated from the LED bulb 70.

As illustrated in FIG. 3, one LED bulb 70 is allocated to one small metal PCB 60, and the plurality of metal PCBs 60 having the LED bulbs 70 are connected to one another. Alternatively, the LED bulbs 70 may be arranged on a single wide metal PCB 60.

The LED lighting fitting is further equipped with a circuit board having a control chip so as to be able to control operation of the LED lighting fitting.

The LED lighting fitting cooling system according to an embodiment of the present invention is mounted above the LED lighting fitting, and serves to efficiently cool the LED lighting fitting. To this end, the LED lighting fitting cooling system generally includes a heat sink 30, at least one cooling fan 20, at least one thermoelectric element 50, and at least one temperature sensor 40.

The heat sink 30 is located above the metal PCB 60, and serves to absorb heat from the LED bulbs 70 and then dissipate the heat into the air. The heat sink 30 is formed of metal having high thermal conductivity, and may have a plurality of fins so as to increase a surface area and the resulting heat radiating effect as illustrated in FIGS. 1 through 3.

The cooling fan 20 is mounted on the heat sink 30, and serves to send air toward the heat sink 30 such that the heat sink 30 can more rapidly dissipate the heat into the air. One or more cooling fans 20 may be mounted. The number of cooling fans 20 may be determined depending on size and output power of the LED lighting fitting.

A cooling cover 10 covering the cooling fan 20 is further installed above the heat sink, and serves to protect the cooling fan 20 and prevent the cooling fan 20 from being exposed to the outside so as to be able to provide a simple, smart appearance. Here, to prevent cooling performance of the heat sink 20 from being reduced by the cooling fan 20, as illustrated in FIGS. 1 and 2, a lower end of the cooling cover 10 is spaced apart from the heat sink 30 by a predetermined distance, so that the air sent by the cooling fan 20 can be smoothly discharged to the outside.

The thermoelectric element 50 particularly employs a Peltier element. The Peltier element is designed to absorb heat on one side and to dissipate heat on the other side when current is flowing. The operating principle of the Peltier element is known, and so a detailed description will be omitted.

The thermoelectric element 50 is installed between the heat sink 30 and the metal PCB 60 of the LED lighting fitting, and is preferably located so as to be in contact with a lower surface of the heat sink 30. The thermoelectric element 50 serves to rapidly absorb the heat from the LED bulbs 70 with efficiency, and transfer the absorbed heat to the heat sink 30.

The thermoelectric element 50 is disposed in such a manner that an upper portion thereof in contact with the heat sink 30 acts as a heat radiating part 51 and that a lower portion thereof in contact with the metal PCB 60 of the LED lighting fitting acts as a heat absorbing part 52. More specifically, the heat absorbing part 52 of the thermoelectric element 50 absorbs the heat from the plurality of LED bulbs 70 in direct contact with the metal PCB 60 of the LED lighting fitting, thereby cooling the LED lighting fitting. In contrast, the heat generated from the heat radiating part 51 of the thermoelectric element 50 is transferred to the heat sink 30, and then is dissipated toward the outside. This heat is more rapidly dissipated outwards by the cooling fan 20.

One or more thermoelectric elements 50 may be mounted. The number of thermoelectric elements 50 may be determined depending on the size and output power of the LED lighting fitting.

The temperature sensor 40 is disposed at a lower portion of the heat sink 30, and measures a temperature of the heat sink 30 or the metal PCB 60. Information on the temperature measured by the temperature sensor 40 is sent to a controller (not shown) of the circuit board. The controller of the circuit board controls driving of the cooling fan 20 on the basis of the temperature information so as to prevent the LED lighting fitting from rising beyond a predetermined temperature. The controller of the circuit board controls the switching on/off of the cooling fan 20. If necessary, the controller may control the revolutions per minute (rpm) of the cooling fan 20.

Meanwhile, the thermoelectric element 50 is configured to be driven whenever powered on. If necessary, the controller of the circuit board may be configured to control the driving of the thermoelectric element 50.

In this manner, a device that controls the switching on/off of the electric device according to the temperature using the temperature sensor 40 and controller is called a thermostat. In the embodiment of the present invention, the thermostat composed of the temperature sensor and controller controls the cooling fan 20 and/or the thermoelectric element 50 according to temperature.

Meanwhile, a fixing plate 80 may be further installed under the thermoelectric element 50. In detail, the fixing plate 80 may be configured such that an upper surface thereof is in contact with the heat absorbing part 52 of the thermoelectric element 50 and that a lower surface thereof is in contact with the upper surface of the metal PCB 60.

When the metal PCB 60 is thin, a difference in temperature between portions adjacent to and distant from the LED bulbs 70 is somewhat great, and thus heat is not uniformly distributed on the metal PCB 60, so that the heat cannot rapidly radiate. In this case, the fixing plate 80 may be additionally installed on the upper surface of the metal PCB 60 so as to be in contact with the thermoelectric element 50.

The fixing plate 80 is also formed of, but not limited to, aluminum having high thermal conductivity.

Either an existing air cooling system configured of the heat sink only or an existing oil cooling system fails to efficiently control the heat generated from the LED lighting fitting, and thus the temperature of the heat sink rises to 50° C. or more. As a result, the existing cooling systems reduce the lifetime of the LED lighting fitting, and thus the LED lighting fitting fails to achieve high output power and luminance. However, in the case of the LED lighting fitting cooling system according to an embodiment of the present invention, the heat sink 30 is maintained at a temperature of about 35° C., so that the lifetime of the LED bulbs is increased to a maximum of 80,000 hours, and thus the durability of the LED bulbs is greatly improved. Accordingly, the LED bulbs having high output power are used for LED lighting fittings having a small size, so that the LED lighting fitting having high luminance can be acquired. Further, the LED lighting fitting having many LED bulbs having high output power can be easily manufactured. Consequently, the LED lighting fitting can be manufactured so as to have higher output power, luminance, and durability for home or commercial use as well as public use as in a street lamp.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A cooling system for a modular light emitting diode (LED) lighting fitting, in which the cooling system is installed at an upper portion of the LED lighting fitting having a plurality of LED bulbs, the cooling system comprising:
a heat sink;
at least one cooling fan located at an upper portion of the heat sink and inducing heat radiating from the heat sink to an outside to cool the heat sink;
at least one thermoelectric element provided at a lower portion of the heat sink and having a heat absorbing part at a lower portion thereof and a heat radiating part at an upper portion thereof, the heat absorbing part being in contact with the LED lighting fitting, and the heat radiating part being in contact with the heat sink; and
at least one temperature sensor mounted at the lower portion of the heat sink,
wherein the cooling fan is controllably driven to cool the LED lighting fitting according to whether or not a temperature measured by the temperature sensor reaches a preset temperature.

2. The cooling system as set forth in claim 1, further comprising a fixing plate at the lower portion of the thermoelectric element.
